(19) United States
(12) Patent Application Publication
(10) Pub. No.: US 2017/0374065 A1
(43) Pub. Date: Dec. 28, 2017

(54) METHOD AND APPARATUS FOR PERFORMING OPERATIONS ASSOCIATED WITH BIOMETRIC TEMPLATES

(71) Applicant: Alex Shtraym, Chicago, IL (US)

(72) Inventor: Alex Shtraym, Chicago, IL (US)

(21) Appl. No.: 15/195,882

(22) Filed: Jun. 28, 2016

(51) Int. Cl. H04L 29/06; G06K 9/62; G06K 9/00

(52) U.S. Cl. CPC H04L 63/0861; H04L 63/10; G06K 9/00892; G06K 9/6202

(57) ABSTRACT

A biometric device configured to perform operations associated with biometric characteristics. A non-volatile, non-transitory memory within the device will contain enrolled biometric templates related to a biometric measurable by a biometric sensor. The enrolled biometric templates are associated with at least one predetermined operation the device can perform. In some embodiments, a combination of two or more enrolled biometric templates may be associated with a predetermined activity different from predetermined activities associated with the each enrolled biometric template. One method includes extracting biometric features from biometric data and generating a biometric template. An output signal will be provided based on the predetermined operation associated with an enrolled biometric template matching a generated biometric template. The output signal may be sent to internal components of the biometric device or to a second device over a wired or wireless link.

### FIELD OF THE DISCLOSURE

The present disclosure relates generally to biometric recognition and more particularly to processing operations associated to biometric templates.

### BACKGROUND

Biometric systems are becoming a popular integrated feature in many devices. For example, biometric authentication is a feature in mobile devices that offers a convenient means of authenticating a user without the need of inputting a password. Although biometric components and features are ever expanding, their most sought out use has been for security and authentication purposes. As the need for protection and privacy continues to increase, so do the complicated algorithms and combination of biometric authentication required to keep devices secure.

Unfortunately, as the development of biometrics increases, so does the possibility of falsing or spoofing. Therefore, the systems that provide the highest amount of security are matched by an enormous price that is infeasible for general public. The convenience and quickness offered by biometric authentication may be implemented in other means that are not a security concern to improve the efficiency and effectiveness of devices.

### BRIEF DESCRIPTION OF THE DRAWINGS

FIG. 1 is a block diagram of a device having a biometric sensor and providing an output signal in accordance with an embodiment.

FIG. 2 is a block diagram of a second device providing an output signal in response to a first device biometric system in accordance with an embodiment.

FIG. 3 is a block diagram of a biometric system in a device having various possible biometric sensors in accordance with an embodiment.

FIG. 4 is a flowchart showing a method of operation in a biometric device using a biometric template to provide a control output signal in accordance with an embodiment.

FIG. 5 is a flowchart showing a method of operation using in a biometric device using a biometric template to provide a control output signal in accordance with an embodiment.

FIG. 6 is a flowchart showing a method of operation using at least one biometric template is generated in order to provide an output signal in accordance with an embodiment.

FIG. 7 is a flowchart showing a method of operation using multiple biometric sensors to provide different output signals in accordance with an embodiment.

### DETAILED DESCRIPTION

The present disclosure provides for a device that can extract biometric data from a biometric sensor. The device is capable of generating a biometric template that can be matched to an enrolled biometric template stored in the memory of the device. Enrolled biometric templates are associated with predetermined operations which the device can perform. In response to the match between the generated biometric template and the enrolled biometric template, the device will provide an output signal corresponding to the predetermined operation associated with the enrolled biometric template.

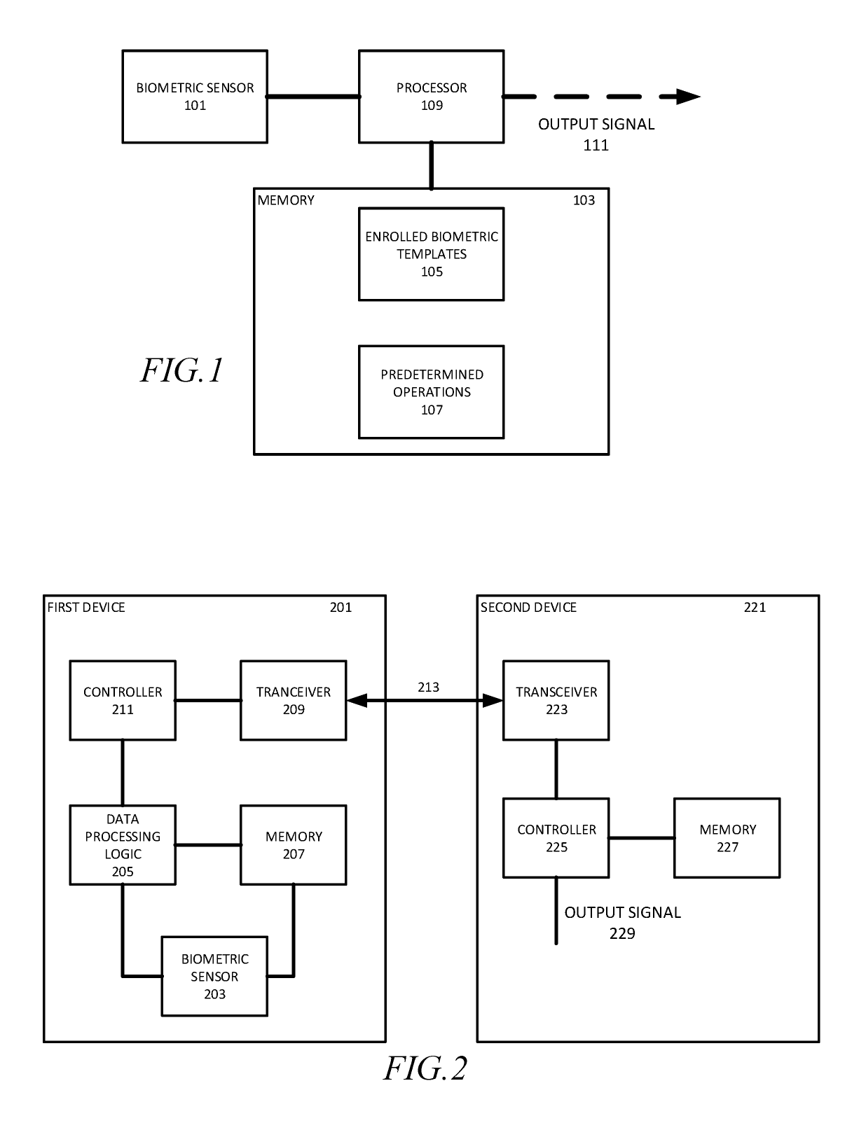

Turning now to the drawings wherein like numerals represent like components, FIG. 1 is a block diagram of a biometric device 100 that includes a biometric sensor 101 in accordance with the embodiments. The biometric device 100 includes a non-volatile, non-transitory memory 103 that contains one or more enrolled biometric templates 105. Memory 103 further includes predetermined operations 107 which may be in list form. The biometric sensor 101 and memory 107 are operatively coupled to a processor 109. The various components and devices that are described herein as being “operatively coupled” refers to such operative coupling as that having, in some embodiments, one or more intermediate or intervening components that may exist between, or along the connection path between two such components such that the components are understood to be operatively coupled in that data, commands or control signals can be sent from one to the other and vice versa.

The processor 109 obtains raw sensor data from the biometric sensor 101 and extracts relevant biometric features. The processor 109 is operative to use the extracted biometric features to generate corresponding biometric templates for matching with enrolled biometric templates 105 stored in memory 103. The memory 103 contains one or more enrolled biometric templates related to one or more predetermined operations of the biometric device 100. In some embodiments, predetermined operations 107 may be related to operations of an external device (not shown).

A biometric template represents a digital reference of a distinct characteristic of an individual that has been extracted from a biometric sample. Biometric characteristics may be measured from various parts of a human body, such as finger tips, facial structure, irises, voice, etc. A processor may then generate a biometric template from the obtained biometric sensor data and match it to an enrolled biometric template. An enrolled biometric template is a biometric template that a user has provided to the biometric system, using a biometric enrollment procedure. The procedure for enrolling a biometric template may include a user selecting and associating an operation that the device can perform to a biometric template generated by a processor. However, it is to be understood that other procedures, such as voice input or input from external devices, may be implemented in order to associate a biometric template with an operation.

Operations that can be associated with an enrolled biometric template may include, but are not limited to, network operations, location operations, information operations, telephonic operations, payment operations, device application operations, storage operations or combinations thereof. An operation, as provided herein, may correspond to performing a process or series of processes on a device that usually requires a physical input using a touchscreen display or a button. A network operation may include any various operation that a user may perform on the device that is associated with connecting to or receiving and transferring data over a wired or wireless network. For example, a network operation may be a data request to a server. A location operation may include coordinating or locating a desired destination using various hardware or software components. For example, a biometric template may be associated with a static location that can automatically be coordinated using a mapping software or GPS hardware. Information operations may include producing information stored in the device such as, but not limited to, music, images, recordings, contacts, settings, etc. For example, an information operation could correspond to retrieving a “favorites” contact list stored in a memory of the device. Telephonic operations may include any telephonic operation a device has such as, but not limited to, making a phone call, sending a text message, listening to voicemail, etc. Payment operations may include associating a biometric template with a payment method. For example, an enrolled biometric template may be associated with information relating to a specific credit card or credentials to access a payment platform (e.g. PayPal®). Device application operations may include opening applications stored on a device, such as a gaming or viewing application (e.g. Netflix®). A storage operation may include any suitable feature for storing desired data on a memory internal or external (i.e. cloud based) to the device. It is to be understood that the operations mentioned above are exemplary and not limiting such that other processes may be performed, such as controlling the operational state (e.g. power down mode), by the biometric device 100.

Once the processor 109 determines that a biometric template matches an enrolled biometric template, the processor 109 will provide an output signal 111 based on the predetermined operation associated with the enrolled biometric template. The output signal may be a command signal corresponding to an operation. If a biometric template does not match one of the enrolled biometric templates 105 stored in memory 103, the device may provide the user with an option to associate the generated biometric template with an operation. If the processor 109 detects that the generated biometric template is associated with an operation, the processor 109 will store the biometric template in memory 103 with the enrolled biometric templates 105 and the associated operation will be stored with the predetermined operations 107 in memory 103. The biometric templates 105 and predetermined operations 107 may be stored in a list form, however, other variations and methods of storage may be used.

In order for a biometric measurement to be made, the biometric device 100 will utilize a biometric sensor 101 to scan a user's body part. Biometric sensors can be a ubiquitous technology such as a microphone for voice capture, a fingerprint sensor or a camera for facial or iris recognition. Other specially designed units may be used, such as those that scan vein patterns under the skin. It is to be understood that in various embodiments, other biometrics may be used, such as, but not limited to, body odor detection, body heat signature detection and some other biometrics.

The biometric device 100 may be any suitable electronic device having a biometric sensor. For example, the biometric device 100 may be an automobile having a biometric sensor on a steering wheel, such that when a biometric template matches an enrolled biometric template, an output signal is provided by the automobile such that the driver's seat is electronically moved to a position based on the seat position information associated with the enrolled biometric template. In another example, the biometric device 100 may be a mobile or wearable device such that when a biometric template matches an enrolled biometric template, a signal is provided such that a phone call is placed to another device who's contact information is associated with the enrolled biometric template. It is to be understood that the methods and operations are not limited to an automobile or mobile device.

FIG. 2 illustrates another implementation of a biometric system where a second device provides a command signal in response to a first biometric device. The example biometric system of FIG. 2 includes a first device 201 having data processing logic 205 and a memory 207. The first device 201 further includes a transceiver 209 operatively coupled to a controller 211. The controller 211 is operatively coupled to the data processing logic 205 which is further operatively coupled to a biometric sensor 203. The data processing logic 205 is operative to obtain raw sensor data from the biometric sensor 203 and generate a biometric template. The data processing logic 205 will match the generated biometric template to an enrolled biometric template stored in memory 207. The memory 207 will also store predetermined operations for enrolled biometric templates. The controller 211 is operative to communicate with the transceiver 209 in order to pass the predetermined operation information to a second device 221 over a wireless link 213 between the transceiver 209 and the transceiver 223 within the second device 221.

The transceiver 223, within the second device 221, is operatively coupled to a controller 225. The controller is operative to receive the predetermined operation information from transceiver 209 sent to it from the first device 201. The controller 225 is operatively coupled to a memory 227, such that the predetermined operation information sent from the first device 201 may be understood (i.e. decoded) by the second device 221. The controller 225 of the second device 221, based on the predetermined operation information, will provide an output signal 229 associated with the enrolled biometric template found in the first device 201. The output signal 229 may be returned to the first device 201 over the wireless link 213, may be sent to a third device (not shown), or may process an operation associated with the enrolled biometric template from the first device 201 on the second device 221. For example, in some embodiments, the output signal 229 establishes a Bluetooth® connection between the first device 201 and the second device 221. In another example, the first device 201 may be a mobile device and the second device 221 may be a printer or monitor, such that a command output signal 229 from the first device 201 is an input on the second device 221 to print or display the signal in a user understandable format (e.g. readable text).

In some embodiments, the first device 201 may be a mobile device or a wearable device due to convenience and accessibility. A mobile device may be a laptop, tablet computer, media player, phone, GPS unit, remote control, personal digital assistant (PDA), and the like, and devices combining some or all of this functionality. On the other hand, a wearable device may have any suitable structure and therefore include a watch, ring, button, bracelet, belt buckle, etc. Wearable devices may also be sewn into an article of clothing, such as a shirt or pants, etc. For example, a user that lost their mobile device may be wearing a ring (i.e. wearable device) having a biometric sensor and an enrolled biometric template corresponding to a sound operation, wherein the ring is capable of generating and matching biometric templates to enrolled biometric templates such that a signal is sent to the mobile device instructing the mobile device to perform an operation which produces an audible sound by the mobile device, thereby allowing the user to locate the mobile device when the ring determines that the enrolled biometric template matches the fingerprint template.

In some embodiments, the second device 221 will include a separate data processing logic (not shown) capable of performing the same operations as data processing logic 205. The second device 221 will receive biometric data from biometric sensor 203 of the first device 201 over wireless link 213. The data processing logic in the second device 221 will obtain and generate a biometric template using the biometric data received at transceiver 223 from transceiver 209 of the first device 201. Memory 227 will include enrolled biometric templates and predetermined operations associated with the enrolled biometric templates. The data processing logic will match the generated biometric template to the enrolled biometric template stored in memory 227. Controller 225 will produce the output signal 229 for the predetermined operation associated with the matched enrolled biometric template stored in memory 227. As above, the output signal 229 may be returned to the first device 201 over the wireless link 213, may be sent to a third device (not shown), or may process an operation associated with the enrolled biometric template on the second device 221.

The wireless transceiver 209 of the first device 201 and transceiver 223 of the second device 221, may utilize any suitable wireless technology such as IEEE 802.11 (also referred to as WiFi®), Bluetooth®, Wireless USB, ZigBee, Bluetooth® Low Energy (also referred to as “Bluetooth® Smart”) or any other suitable wireless technology that may form the wireless link 213 between the first device 201 and the second device 221 to transfer information or output command and control signaling there-between. The first device 201 and the second device may go through a pairing procedure or a connection procedure depending on the wireless technology employed. The second device 221, may be any suitable electronic device such as a television, remote, automobile, mobile device or similar device. In some embodiments, one of the devices may be at a fixed location and the other device may be a mobile device or wearable. For example, the second device 221 may be a television having network capabilities (“Smart TV”). If the first device 201 is a mobile or wearable device, the first device 201 may send command and control signals (e.g. operational instructions) to the second device 221 after a pairing or authentication procedure is complete.

Therefore, the wireless transceivers of the first device 201 and the second device 221 can each receive wireless signals from, and send wireless signals to, the other device wireless transceiver over wireless link 213. For example, controller 225 within the second device 221 may send a command signal to the data processing logic 205 of the first device 201 to retrieve operational information.

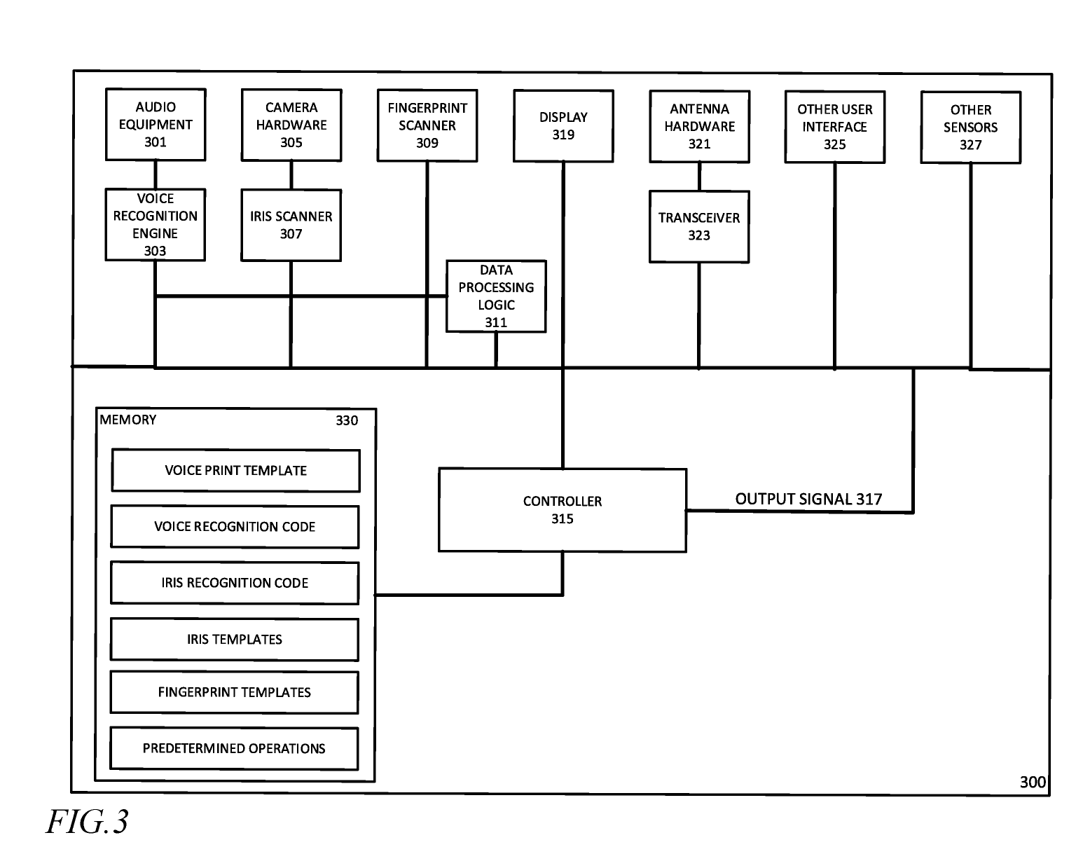

Another embodiment of a biometric system is illustrated in FIG. 3. A biometric device 300 includes audio equipment 301, camera hardware 305 and a fingerprint scanner 309. Audio equipment 301 includes at least one microphone and is operatively coupled to a voice recognition engine 303 and data processing logic 313. The camera hardware 305 includes at least one camera and is operatively coupled to an iris scanner 307 and the data processing logic 313. Camera hardware 305 can include any suitable device for detecting images based on light and may include multiple cameras at different locations of the device 300 (e.g. a front and a back camera). The fingerprint scanner 309 is also operatively coupled to the data processing logic 313. The various components of biometric device 300 are operatively coupled to a controller 315. The controller 315 is operative to issue an output signal 317 to the various components of the biometric device 300.

The audio equipment 301 may include, among other things, at least one microphone, at least one speaker, signal amplification, analog-to-digital conversion/digital audio sampling, echo cancellation, and other audio processing, etc., which may be applied to one or more microphones and/or one or more speakers of the biometric device 300. The camera hardware 303 may include, among other things, at least one camera, any appropriate image sensor, such as, but not limited to, a charge-coupled device (CCD), CMOS chip, active-pixel sensor (APS), Bayer sensor, etc. The fingerprint scanner 309 may include a flexible substrate with various components for scanning a surface in order to capture an image of a fingerprint or other extremity.

The output signal 317 produced by the controller 315 may be to a component of the biometric device 300 or may be to an external system that is physically external from the biometric device 300. The biometric device 300 various components may include a display 319, antenna hardware 321, including a transceiver 323, other user interfaces 325, which may include, but is not limited to, a keyboard, touch sensors, mouse, buttons, etc., and other sensors 327, such as a gyroscope and accelerometer (which may be separate or integrated in a single package). The controller 315 is operatively to the components mentioned above and to a non-volatile, non-transitory memory 330.

The memory 330 includes voice print templates 331, voice recognition code 333, iris recognition code 335, iris templates 337, fingerprint templates 339 and predetermined operations 341. The various executable codes and templates in memory 330 correspond to the voice recognition engine 303, the iris scanner 307 and the fingerprint scanner 309. The voice print templates 331, iris templates 337 and fingerprint templates 339 are enrolled biometric template databases that contain biometric templates of at least one user that has been enrolled through a biometric enrollment process. The predetermined operations 341 may be stored in various forms, such as a list associating a predetermined operation with an enrolled biometric template, and correspond to the output signals provided by the controller 315.

The biometric templates generated by the data processing logic 311 are matched by the controller 315 to an enrolled biometric template stored in memory 330. Based on the biometric sensor used, the controller will compare the generated template to the proper enrolled template in memory 330. If the controller 315 detects a matching enrolled biometric template to the generated biometric template, the controller 315 will obtain the associated predetermined operation from memory 330 and issue an output signal 317 to the corresponding components of the biometric device 300. In some embodiments, the controller 315 will use the antenna hardware 321 of the biometric device 300 to output a command signal 317 containing the predetermined operation to a second device. In other embodiments, the controller 315 will use the antenna hardware 321 of the biometric device 300 to transfer biometric data, rather than a biometric template, from one or more sensors to a second device. Antenna hardware 321 includes any known or developed structure for receiving electromagnetic energy in the radio frequency (RF) spectrum. For example, transceiver 323 may encode or decode data using amplitude modulation, frequency modulation, phase modulation or any combination thereof.

The biometric process may be initiated in the various embodiments using a variety of approaches. In one approach, a biometric sensor within the biometric device 300 may send out a reflective signal periodically to determine whether a user is present (i.e. whether a fingerprint or iris is nearby and being detected). Because the device 300 may be powered by batteries, in some embodiments, this approach is periodic in order to conserve battery power. For a fixed device where power may be provided from a power source other than a battery, power conservation is less of an issue and therefore the biometric sensors within the biometric device 300 may be constantly scanning and processing data to match an enrolled biometric template. In other embodiments, a sensor, such as a proximity sensor, may be used as a trigger to the biometric device 300 to initiate the processing and matching of biometric templates. Another approach may be a user input to initiate the process or an input to wake a device from a powered down state (i.e. sleep mode). Any other approach to initiate the biometric process may be used in the various embodiments.

Various selectable buttons and/or selectable features of display 319 may be selected in various ways in accordance with the embodiments, such as, but not limited to, mouse cursor point-and-click, touch screen, scrolling a cursor to the selectable item and hitting an “enter” key, using hot keys corresponding to the selectable feature, voice commands, etc., or any other suitable way of selecting a selectable feature.

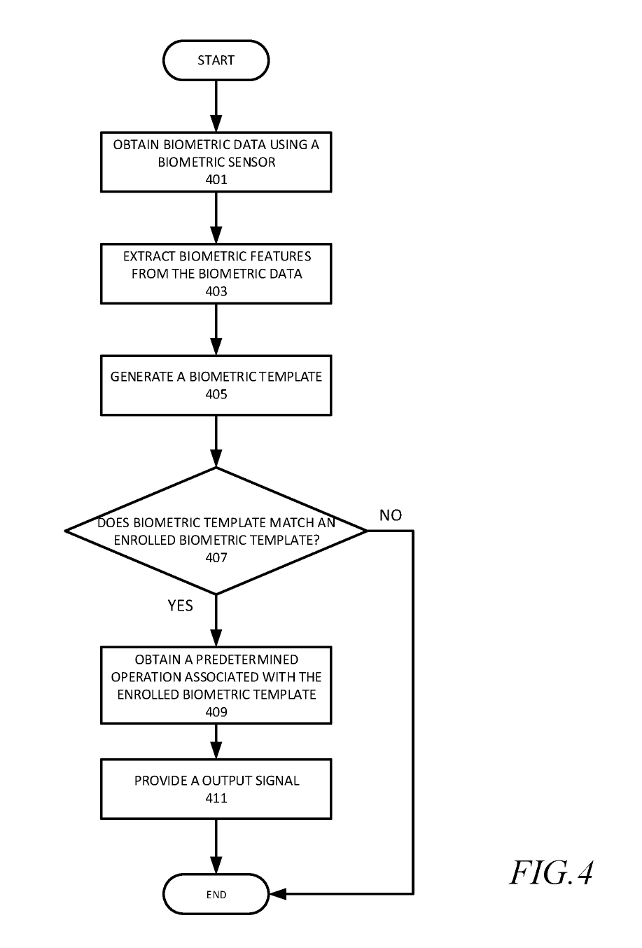

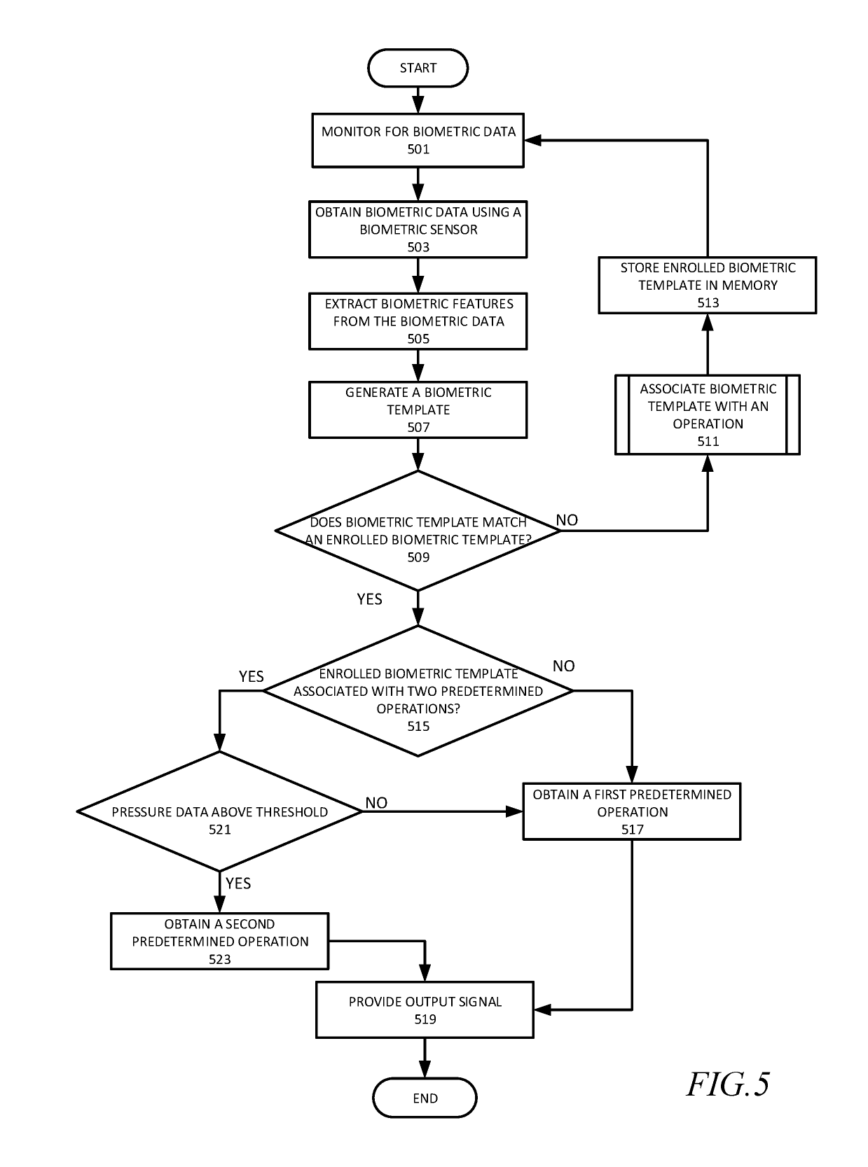

FIG. 4 is a flowchart showing a method of operation using a biometric template to provide a control output signal, in accordance with an embodiment. The method of operation begins and in operation block 401, the processor of the biometric device obtains biometric data using a biometric scanner. In operation block 403, the processor extracts biometric features from the biometric data. In operation block 405, the processor generates a biometric template using the extracted biometric features. In decision block 407, the processor determines whether the generated biometric template matches an enrolled biometric template that is stored in memory. If there is no match, the method of operation ends. If at decision block 407, the processor determines that there is a match between the generated biometric template and the enrolled biometric template, in operation block 409, the processor obtains a predetermined operation that is associated with the matching enrolled biometric template. In operation block 411, the processor provides an output signal corresponding to the predetermined operation.

FIG. 5 is a flowchart illustrating a method of operation in a biometric device, in accordance with an embodiment. The operation begins and in operation block 501, the biometric device monitors for biometric data using a biometric sensor. In operation block 503 data processing logic in the biometric device obtains biometric data using the biometric sensor. In operation block 505, the data processing logic extracts biometric features from the biometric data. In operation block 507, the data processing logic generates a biometric template. In decision block 509, a controller determines whether the generated biometric template matches an enrolled biometric template stored in memory. If not, in sub-process block 511, the controller may associate the biometric template with an operation. The controller may detect an input on the biometric device that is to be associated with the biometric template. For example, the controller c may detect a selection associated with opening an application on the mobile device. In operation block 513, the controller may store the biometric template with the associated operation (i.e. opening application) in memory of the biometric device and the method of operation reverts back to operation block 501. Therefore, if the data processing logic were to generate the same biometric template at a later time, the controller would match it to the enrolled biometric template associated with opening the application.

If at decision block 509, the controller determines that the generated biometric template matches an enrolled biometric template, in decision block 515, the controller determined whether the enrolled biometric template is associated with more than one predetermined operations. If the enrolled biometric template is associated with only one predetermined operation, in operation block 517, the controller determines the predetermined operation and in operation block 519, the controller within the biometric device provides an output signal associated with the first (i.e. only) predetermined operation. If at decision block 515, the matching enrolled template is associated with two predetermined operations, in decision block 521, the controller determines whether pressure data from a pressure sensor is above a designated threshold. If not, the method of operation continues to operation block 517 and operation block 519, where the controller provides an output signal associated with the first predetermined operation. If at decision block 521, the controller obtains that the pressure data from the pressure sensor is above a desired threshold, in operation block 523, the controller obtains a second predetermined operation for the enrolled biometric template. In operation block 519, the controller provides an output signal associated with the second predetermined operation.

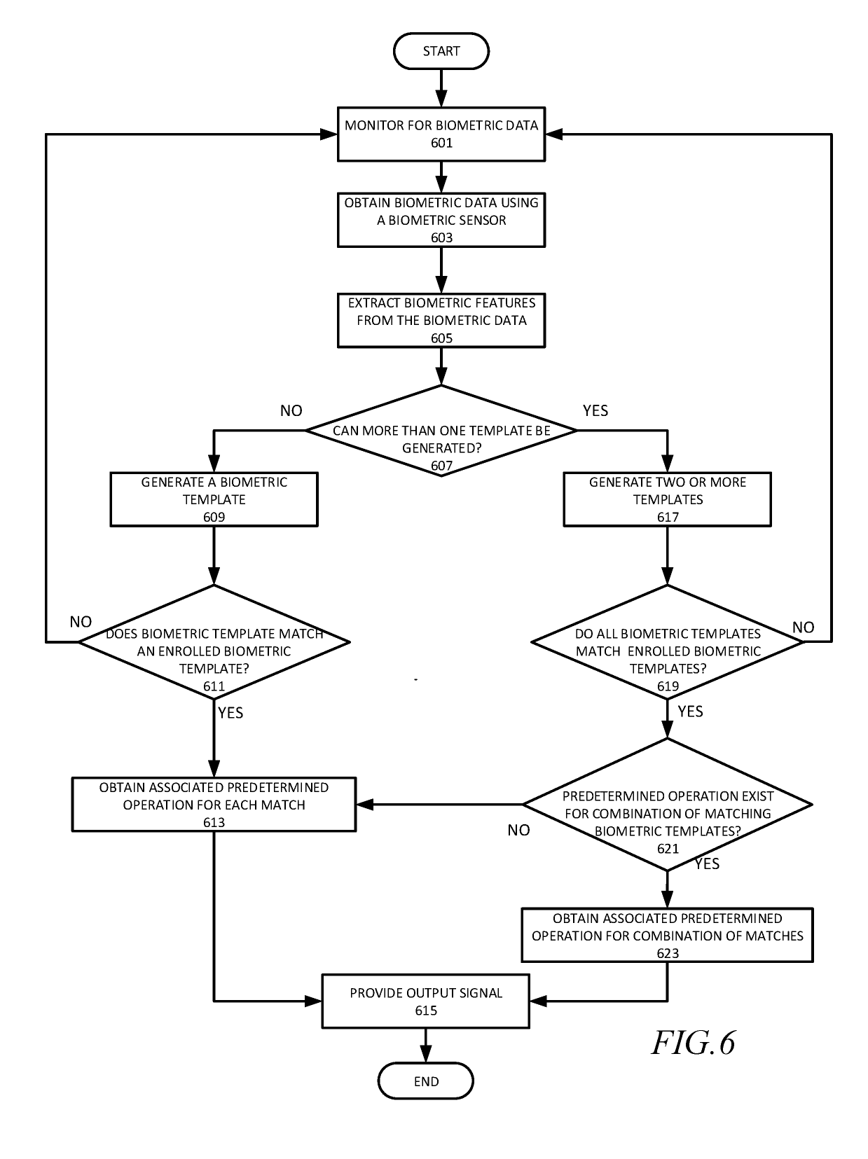

FIG. 6 illustrates a method of operation within a biometric device using at least one enrolled biometric template to provide an output signal. The operation begins and in operation block 601, the biometric device, having a biometric scanner, monitors for biometric data. In operation block 603, the data processing logic within the biometric device obtains biometric data from the biometric scanner. In operation block 605, the data processing logic extracts biometric features from the obtained biometric data. In decision block 607, the data processing logic determines whether more than one template can be generated. In some embodiments, more than one biometric template may be generated when a biometric sensor is capable of attaining several biometric features. For example, if the biometric device detects two or more fingerprints on a fingerprint sensor, the data processing logic may generate two biometric templates from the biometric data of each biometric sensor. Enrolled biometric templates stored in memory of the biometric device may be combined and associated with a distinct operation as compared to the operation associated with the enrolled biometric templates individually.

If at decision block 607, only one biometric template can be generated, in operation block 609, the data processing logic generates a biometric template. In decision block 611, a controller determines whether the generated biometric template matches an enrolled biometric template stored in memory of the biometric device. If not the operation reverts back to operation block 601. If in decision block 611, the generated biometric template matches the enrolled biometric template, in operation block 613, the controller obtains an operation associated with the enrolled biometric template. In operation block 615, the controller provides an output signal based on the associated predetermined operation of the matching enrolled template.

If more than one template can be generated at decision block 607, in operation block 617, the data processing logic generates two or more templates. In decision block 619, the controller determines whether all the generated biometric templates match at least one enrolled biometric template. If not, the method of operation reverts back to operation block 601. If in decision block 619, the controller determines that all generated biometric templates match at least one enrolled biometric template, in decision block 621, the controller determines whether a predetermined operation exists for the combination of matching biometric templates. If no predetermined operation exists for the combination of matching templates, in operation block 613, the controller obtains a separate predetermined operation associated with each matched enrolled biometric template. In operation block 615, the controller provides an output signal based on the associated predetermined operation of each matching enrolled biometric template. For example, a command signal is output to display an image on a display of the biometric device. If in decision block 621, the data processing logic determines that a single predetermined operation exists for the combination of matching biometric templates, in operation block 623, the controller determines the associated predetermined operation for the combination of matched enrolled biometric templates. The operation continues, as before, to operation block 615, where the controller provides an output signal based on the associated predetermined operation for the combination of matching enrolled biometric templates.

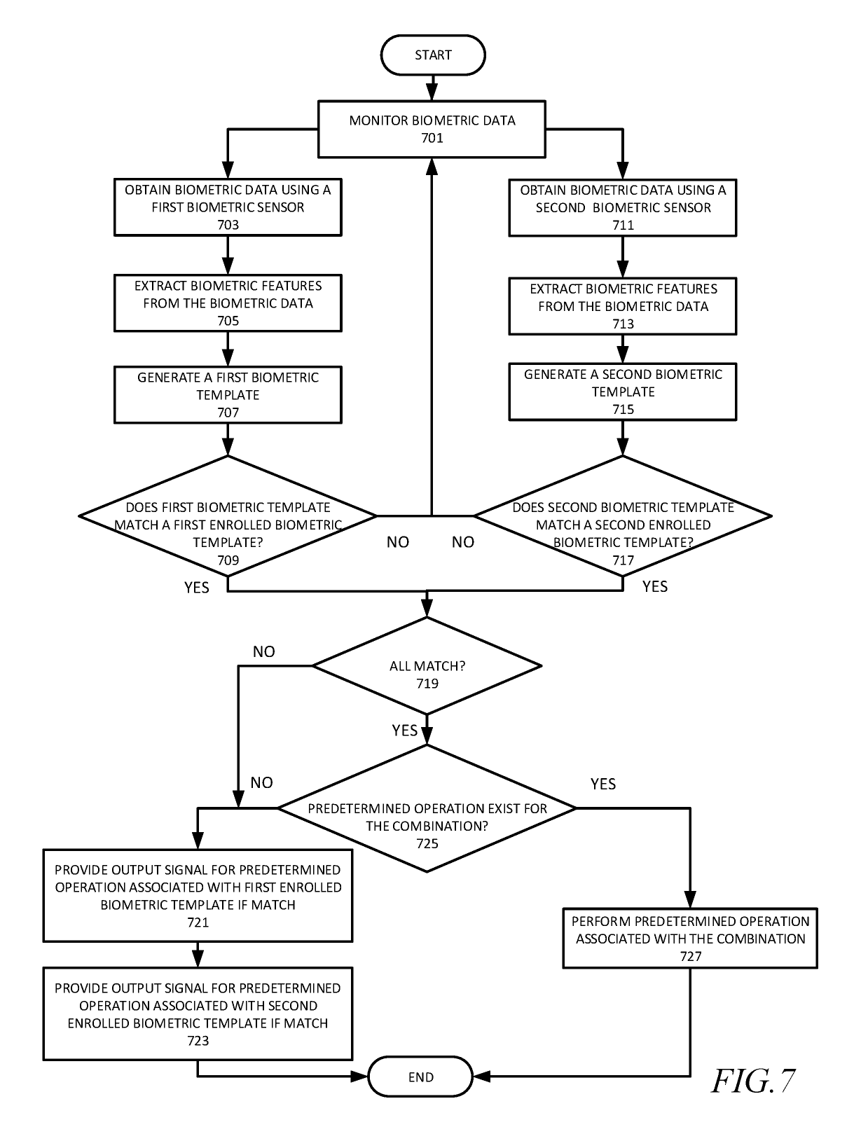

FIG. 7 is a flowchart showing another implementation of the biometric device generating multiple biometric templates from multiple biometric sensors to provide different output signals in accordance with an embodiment. The operation begins and in operation block 701, the biometric device monitors biometric data from a plurality of biometric sensors. In operation block 703, data processing logic within the biometric device obtains biometric data from a first biometric sensor. In operation block 705, the data processing logic extracts the biometric features from the biometric data from the first biometric sensor. In operation block 707, the data processing logic generates a first biometric template using the biometric data of the first biometric sensor. In decision block 709, a controller determines whether the first generated biometric template matches a first enrolled biometric template. In operation block 711, the data processing logic obtains biometric data using a second biometric sensor. In operation block 713, the data processing logic extracts the biometric features from the biometric data and in operation block 715, the data processing logic generates a second biometric template. In decision block 717, the controller determines whether the generated second biometric template matches a second enrolled biometric template. If either first generated biometric template at decision block 709 or second biometric template in decision block 717 match an enrolled biometric template, the method of operation continues to decision block 719. If both generated templates fail to match an enrolled biometric template, the method of operation reverts back to operation block 701.

In decision block 719, the controller determines whether the first generated biometric template matches the first biometric enrolled template and the second generated biometric template matches the second enrolled biometric template. If both the first and second generated biometric templates do not match the first and second enrolled biometric templates, respectively, at decision block 719, the operation continues to operation block 721 and operation block 723. In operation block 721, the controller provides an output signal for a predetermined operation associated with the first enrolled biometric template if the first generated biometric template matches the first enrolled biometric template. In operation block 723, the controller provides an output signal for a predetermined operation associated with the second enrolled biometric template if the second generated biometric template matches the second enrolled biometric template.

If in decision block 719, all generated templates match all enrolled templates, the method of operation continues to decision block 725, the controller determines whether a predetermined operation exists for the combination of matched enrolled biometric templates. If no predetermined operation is associated with the combination of matching biometric templates in decision block 725, in operation block 721, the controller provides an output signal for a predetermined operation associated with the first enrolled biometric template and in operation block 723, the controller provides an output signal for a predetermined operation associated with the second enrolled biometric template. If at decision block 723, a predetermined operation exists for the combination of enrolled biometric templates which match the generated biometric templates, in operation block 727, the controller outputs a signal associated with the predetermined operation associated with the combination of matched enrolled biometric templates.

In the various embodiments where there is more than one biometric sensor, the data processing logic of the biometric device may dynamically perform the initial operations of obtaining, extracting and generating for each biometric sensor. For example, the data processing logic will obtain biometric data from the first biometric sensor and from the second biometric sensor at the same time, and a first biometric template will be generated at the same time a second biometric template is generated so as to allow the controller to determine whether the combination of matching biometric templates is associated with a single predetermined operation.

It is to be understood that the block diagrams provided herein show at least those components necessary to describe the features and advantages of the various embodiments to those of ordinary skill, but that various other components, circuitry, logic, etc. may be present in order to implement various functions and features of the devices such as the example wearable and other mobile devices and that those various other components, circuitry, devices, etc., are understood to be present in the various embodiments by those of ordinary skill.

It is to be understood that information and commands such as, but not limited to, raw biometric sensor data, biometric templates and/or an output signal, sent over the wireless links described herein may be encrypted using any of various suitable data encryption techniques for sending data and/or for communication over wireless links in order to enhance security.

The various components shown and described in the figures corresponding to biometric devices and systems may be implemented independently as software and/or firmware executing on one or more programmable processors, and may also include, or may be implemented independently, using ASICs, DSPs, hardwired circuitry (logic circuitry), or combinations thereof. That is, any of the various described controllers, data processing logic, voice recognition engine, and/or data collection and processing logic components, may be implemented using an ASIC, DSP, executable code executing on a processor, logic circuitry, or combinations thereof.

Each of the various described database components are implemented in the various embodiments via non-volatile, non-transitory computer readable memory. The memory, which is also non-volatile, non-transitory computer readable memory, contains executable instructions or executable code for execution by at least one processor, that when executed, cause the at least one processor to operate in accordance with the functionality and methods of operation herein described. The computer readable memory may be any suitable non-volatile, non-transitory, memory such as, but not limited to, programmable chips such as EEPROMS, flash ROM (thumb drives), compact discs (CDs) digital video disks (DVDs), etc., that may be used to load executable instructions or program code to other processing devices such as mobile devices, including wearable devices, or other devices such as those that may benefit from the features of the herein described embodiments.

Various applications exist for the biometric system disclosed herein and there are various operations that are contemplated by the present disclosure. One such application is to send output signals to find previously hidden data, such as an image stored within several layers of memory. An enrolled biometric template may be associated with a predetermined operation such that a command signal is sent in order to retrieve the hidden data. Alternatively, an enrolled biometric template may be associated with a predetermined operation, such as a locating operation, so that a user can easily find a misplaced item. For example, the misplaced item, having communication capabilities with a biometric device, would exhibit a vibration or sound in response to a signal sent from the biometric device when the enrolled biometric template is matched with to a generated biometric template on the biometric device. The user would have previously gone through the necessary enrolling process in order to associate such operations with the desired biometric characteristic.

An enrolling process may include using a biometric sensor within a biometric device to generate a biometric template. Once a template is generated, a user is prompted, on the biometric device, to select an operation to be associated with the template. After receiving an input corresponding to the selection made by a user, the biometric template associated with the operation and stored in a memory of the biometric device. The stored biometric templated that is associated with the operation is an enrolled biometric template. A user can erase or configure an enrolled biometric template. In other words, an enrolled biometric template can be associated with a different operation without having to generate a new biometric template.

Another application is to combine the output command signal for the predetermined operation sent from the biometric device to an internal or external component with a biometric authentication system. For example, an enrolled biometric template may be associated with the necessary security authentication needed to access a secure room and combining the authentication with a predetermined operation, such as turning on the lights in the secure room, thereby simultaneously sending an authentication signal and a command output signal. Other ways of using and/or combining biometric systems to provide output signals will occur to those of ordinary skill in light of the present disclosure.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

What is claimed is:

1. A biometric device comprising:
non-volatile, non-transitory memory, containing an enrolled biometric template related to a biometric measurable by the biometric sensor, wherein the enrolled biometric template is associated with at least one predetermined operation a device can perform, and wherein a combination of at least two enrolled biometric templates are associated with a predetermined operation the device can perform;
a processor, operatively coupled to the biometric sensor and non-volatile, non-transitory memory, the processor operative to:
extract biometric features from biometric data and generate a biometric template; and
provide an output signal based on the predetermined operation associated with the enrolled biometric template in response to the biometric template matching the enrolled biometric template.

2. The biometric device of claim 1, further comprising:
a biometric sensor; wherein the processor is further operative to:
extract biometric features from biometric data obtained using the biometric sensor and generate a biometric template.

3. The biometric device of claim 3, wherein the processor is further operative to:
provide an output signal based on the predetermined operation associated with the combination of a first enrolled biometric template and second enrolled biometric template in response to a first biometric template matching a first enrolled biometric template and a second biometric template matching a second enrolled biometric template.

4. The biometric device of claim 2, further comprising:
a pressure sensor, operatively coupled to the processor, wherein the processor is further operative to:
obtain pressure data from the pressure sensor corresponding to the pressure applied to the biometric sensor; and
provide an output signal based on the predetermined operation associated with the enrolled biometric template in response to the biometric template matching the enrolled biometric template, wherein each enrolled biometric template is associated with a first predetermined operation when the pressure is below a certain threshold and a second predetermined operation when the pressure is above a certain threshold.

5. The biometric device of claim 1, wherein the processor is further operative to:
associate a biometric template with an operation; and
store the biometric template associated with the operation in the memory, wherein the stored biometric template associated with an operation is an enrolled biometric template.

6. The biometric device of claim 1, wherein the biometric sensor is one of a fingerprint sensor, a microphone, or a camera.

7. The biometric device of claim 1, wherein the predetermined operation corresponds to at least one of a network operation, location operation, information operation, telephonic operation, payment operation, device application operation, and storage operation.

8. A mobile device comprising:
a biometric sensor;
a transceiver;
non-volatile, non-transitory memory, containing at least one enrolled biometric template related to a biometric measurable by the biometric sensor, wherein the enrolled biometric template is associated with a predetermined operation and wherein a combination of at least two enrolled biometric templates are associated with a predetermined operation;
data processing logic, operatively coupled to the biometric sensor, the data processing logic operative to:
extract biometric features from biometric data obtained using the biometric sensor and generate a biometric template; and
a controller, operatively coupled to the data processing logic, the transceiver, and to memory, the controller operative to:
provide an output signal based on the predetermined operation associated with the enrolled biometric template in response to the biometric template matching the enrolled biometric template.

9. The mobile device of claim 10, further comprising:
a second biometric sensor, wherein the data processing logic is further operative to:
extract biometric features from biometric data obtained using a second biometric sensor and generate a second biometric template; and
the controller is further operative to:
provide an output signal based on the predetermined operation associated with the combination of enrolled biometric templates in response to the combination of biometric templates matching the combination of enrolled biometric templates.

10. The mobile device of claim 9, wherein the controller is further operative to:
send the control output signal to either the mobile device or to an external device over a wireless link using the transceiver in the mobile device.

11. The mobile device of claim 9, wherein the biometric sensor is one of at least a fingerprint sensor, an iris scanner and a microphone.

12. The mobile device of claim 9, wherein the predetermined operation corresponds to at least one of a network operation, location operation, information operation, telephonic operation, payment operation, device application operation, and storage operation.

13. A method for controlling an operation in a device using biometric sensors, comprising:
obtaining biometric data using a biometric sensor;
extracting biometric features from the biometric data;
generating a biometric template;
matching the biometric template to an enrolled biometric template stored in memory; and
determining a predetermined operation associated with the enrolled biometric template.

14. The method as set forth in claim 13, further comprising:
providing a command signal based on a predetermined operation associated with the enrolled biometric template in response to the biometric template matching the enrolled biometric template.

15. The method as set forth in claim 13, further comprising:
sending a command signal based on a predetermined operation associated with the enrolled biometric template to an external device in response to the biometric template matching the enrolled biometric template.

16. The method as set forth in claim 13, further comprising:
obtaining biometric data from a second biometric sensor;
extracting biometric features from the biometric data of the second sensor;
generating a second biometric template.

17. The method as set forth in claim 16, further comprising:
determining a predetermined operation associated with the combination of a first biometric template matching a first enrolled biometric template and the second biometric template matching a second enrolled biometric template.

18. The method as set forth in claim 17, further comprising:
providing a command signal based on the predetermined operation associated with the combination of the first biometric template matching the first enrolled biometric template and the second biometric template matching a second enrolled biometric template.

19. The method as set forth in claim 13, further comprising:
obtaining pressure data using a pressure sensor;
matching the biometric template to the enrolled biometric template;
using the sensor data to determine a predetermined operation associated with the enrolled biometric template, wherein the enrolled biometric template has at least one associated predetermined operation; and
providing a command signal corresponding to the predetermined operation associated with the enrolled biometric template and pressure data in response to matching the biometric template with the enrolled biometric template.

20. The method as set forth in claim 13, further comprising:
associating a biometric template with an operation;
storing, in memory, the biometric template, wherein the stored biometric template associated with an operation is an enrolled biometric template.
